(19) United States
(12) Patent Application Publication
(10) Pub. No.: US 2023/0193072 A1
(43) Pub. Date: Jun. 22, 2023

(54) LIQUID CROSSLINKING AGENT AND COATING FLUID OF LIQUID CROSSLINKING AGENT

(71) Applicant: Mitsubishi Chemical Corporation, Tokyo (JP)

(72) Inventors: Akiteru Fujii, Tokyo (JP); Yuqing Xu, Tokyo (JP); Sachiko Sawada, Tokyo (JP); Yuuta Kumano, Tokyo (JP)

(73) Assignee: Mitsubishi Chemical Corporation, Tokyo (JP)

(21) Appl. No.: 18/154,844

(22) Filed: Jan. 15, 2023

Related U.S. Application Data
(63) Continuation of application No. PCT/JP21/26387, filed on Jul. 14, 2021.

(30) Foreign Application Priority Data
Jul. 15, 2020 (JP) 2020-121449

(51) Int. Cl. C09D 163/00; C08J 7/04; C09K 23/44; C09D 133/10

(52) U.S. Cl. CPC C09D 163/00; C08J 7/0427; C09K 23/44; C09D 133/10; C08J 2363/02; C08J 2333/12

(57) ABSTRACT

Provided is a liquid crosslinking agent in which liquid life (pot life) as an undiluted solution is sufficiently long and excellent coating properties are exhibited when used. A liquid crosslinking agent containing an epoxy compound and an emulsifier, in which a content of water is 39% by mass or less with respect to a total amount of a liquid, and a contact angle with respect to a poly(ethylene-methacrylic acid) film when preparing an aqueous dispersion in which a concentration of a non-volatile component is 15% by mass is 42.0° or less. It is preferable that the epoxy compound has two or more epoxy groups in molecules, and it is preferable that the emulsifier is a nonionic surfactant. Provided is a coating method of a liquid crosslinking agent including diluting the liquid crosslinking agent with water to be used for coating.

### CROSS-REFERENCE TO RELATED APPLICATIONS

This application is a continuation of International Application No. PCT/JP2021/026387, filed Jul. 14, 2021, the disclosure of which is incorporated herein by reference in its entirety. The application claims priority to Japanese Patent Application No. 2020-121449, filed Jul. 15, 2020, the disclosure of which is incorporated herein by reference in its entirety.

### TECHNICAL FIELD

The present invention relates to a liquid crosslinking agent and a coating fluid of a liquid crosslinking agent that are used for painting, printing, or the like.

### BACKGROUND ART

A liquid crosslinking agent and a coating fluid of a liquid crosslinking agent that are used for painting, printing, or the like are mainly a solvent type having excellent affinity with an organic material. In general, an organic solvent is used as the solvent, but from the environmental consideration, it is desired to convert the organic solvent to a water-based solution in which little or no solvent is used. In particular, in a liquid crosslinking agent containing an epoxy compound, the epoxy compound is generally supplied as an aqueous solution, or an undiluted solution in an emulsion state of being dispersed in water. The liquid crosslinking agent containing the epoxy compound is coated after being mixed with other water-based coating fluids (Patent Document 1), or is sequentially coated alternately with other coating fluids (Patent Document 2) while being suitably diluted with water. Accordingly, mechanical and thermal durability is improved by a crosslinking/curing reaction with a resin in the coated layer or between the layers.

### CITATION LIST

### Patent Document

Patent Document 1: JP 2011-178897 A
Patent Document 2: JP 2005-281421 A

### SUMMARY OF THE INVENTION

### Problem to be Solved by the Invention

However, in the liquid crosslinking agent containing the epoxy compound of the related art, the epoxy compound was easily decomposed by contact with the contained water over time even while the liquid crosslinking agent was stored as an undiluted solution before being used. As a result thereof, crosslinking performance was degraded, or the epoxy compound was precipitated, and thus, redispersion was required, and a particle diameter increased, and thus, coating properties were degraded, and therefore, it was not necessarily sufficient from the viewpoint of the life (pot life) as the undiluted solution of the liquid crosslinking agent.

The invention is made in consideration of the technology of the related art described above. That is, an object of the invention is to provide a liquid crosslinking agent in which liquid life (pot life) as an undiluted solution is sufficiently long and excellent coating properties are exhibited during use.

### Means for Solving Problem

As a result of intensive studies of the present inventors, it has been found that a liquid crosslinking agent contains an epoxy compound and an emulsifier, a content of water is a predetermined value or less, and a contact angle with respect to a poly(ethylene-methacrylic acid) film when preparing an aqueous dispersion having a specific concentration of a non-volatile component is a specific value or less, and thus, sufficient pot life as an undiluted solution and excellent coating properties can be compatible, and the following invention has been completed.

That is, the outline of the invention is in <1> to <11> described below.

<1> A liquid crosslinking agent, containing: an epoxy compound; and an emulsifier, in which a content of water is 39% by mass or less with respect to a total amount of a liquid, and a contact angle with respect to a poly(ethylene-methacrylic acid) film when preparing an aqueous dispersion in which a concentration of a non-volatile component is 15% by mass is 42.0° or less.

<2> The liquid crosslinking agent according to <1>, in which the epoxy compound has two or more epoxy groups in molecules.

<3> The liquid crosslinking agent according to <1> or <2>, in which the emulsifier is a nonionic surfactant.

<4> The liquid crosslinking agent according to any one of <1> to <3>, further containing a permeation enhancer.

<5> The liquid crosslinking agent according to any one of <1> to <4>, in which the content of water is 0.1% by mass or less.

<6> The liquid crosslinking agent according to any one of <1> to <5>, in which a content of an organic solvent is 0.1% by mass or less.

<7> The liquid crosslinking agent according to any one of <1> to <6>, in which when the liquid crosslinking agent is simply diluted with water by the following method, the liquid crosslinking agent has properties that an average particle diameter of the epoxy compound is 1 μm or less.

Simple dilution indicates an operation of adding water to the liquid crosslinking agent such that a content of the non-volatile component is 15% by mass, and of shaking the liquid crosslinking agent for 1 minute with a weak stirring force.

<8> A coating method of a liquid crosslinking agent, including diluting the liquid crosslinking agent according to any one of <1> to <7> with water to be used for coating.

<9> A coating fluid of a liquid crosslinking agent that is formed by diluting the liquid crosslinking agent according to any one of <1> to <7> with water.

<10> The coating fluid of a liquid crosslinking agent according to <9>, in which the concentration of the non-volatile component is 10% by mass or more.

<11> A substrate, including a coating layer or a printing layer, in which the coating layer or the printing layer has a crosslinking structure of the liquid crosslinking agent according to any one of <1> to <7>.

### Effect of the Invention

According to the invention, it is possible to provide the liquid crosslinking agent in which sufficient pot life as the undiluted solution and excellent coating properties are compatible.

### MODE FOR CARRYING OUT THE INVENTION

Hereinafter, an embodiment of the invention will be described in detail, but the description of the following constituents is a representative example of the embodiment of the invention, and modification can be suitably made within a range not departing from the gist of the invention.

In the following description, unless otherwise specified, the measurement of various physical properties or an operation step is based on a condition of an ordinary temperature and an ordinary pressure.

[Liquid Crosslinking Agent]

A liquid crosslinking agent of the invention is characterized by containing an epoxy compound and an emulsifier, in which a content of water is 39% by mass or less with respect to a total amount of a liquid, and a contact angle with respect to a poly(ethylene-methacrylic acid) film when preparing an aqueous dispersion in which a concentration of a non-volatile component is 15% by mass is 42.0° or less. Note that, here, the concentration of the non-volatile component indicates a content rate (% by mass) of the non-volatile component contained in the liquid crosslinking agent.

The liquid crosslinking agent of the invention can be used in various ways. For example, mechanical and thermal durability can be improved by mixing and coating the liquid crosslinking agent of the invention and other water-based coating fluids to cause a crosslinking reaction in a coating layer, interlayer adhesiveness can be improved by causing an interlayer crosslinking reaction between a base coating layer of other coating fluids and a coating layer of the liquid crosslinking agent of the invention, or mechanical and thermal durability of a coating layer can be improved by coating a coating fluid of a liquid crosslinking agent of the invention after coating other coating fluids, and by allowing a crosslinking component to permeate and react.

In addition, the liquid crosslinking agent of the invention is preferably used for a painting step or a printing step in a facility that is not provided with a dilution apparatus or a dispersion apparatus, and is capable of suppressing an environmental load from the viewpoint of reducing the use of a solvent.

In general, it is known that coating properties of the water-based coating fluid are improved in a case where a contact angle with respect to the surface of a coated layer is decreased. On the other hand, in a case where the liquid crosslinking agent of the invention is used as a coating fluid, it is necessary that not only is the coating fluid homogeneously coated on the surface of the coated layer, but also the coating fluid sufficiently permeates in a depth direction in the coated layer to cause a crosslinking reaction with the coated layer.

In addition, as described above, the liquid crosslinking agent containing the epoxy compound of the related art was easily decomposed by the contact with the contained water even while the liquid crosslinking agent was stored as the undiluted solution before being used, and thus, there were problems that the crosslinking performance of the epoxy compound was degraded, the redispersion was required due to the precipitation of the epoxy compound, or the coating properties were degraded due to an increase in the particle diameter. Regarding such problems, a method of reducing the content of water in the undiluted solution before being used can be used, but a new problem occurs that it is necessary to enable the undiluted solution to be easily dispersed when being used as a coating fluid.

In order to improve the permeableness of the coating fluid in the depth direction in the coated layer, the inventors have optimized the contact angle with respect to the surface of the coated layer. As a result thereof, it has been found that in the case of optimizing the contact angle in a specific numerical range, not only the permeableness of the coating fluid but also the new problem described above can be unexpectedly solved.

Specifically, as a result of the studies of the inventors, it has been found that in order for the coating fluid to sufficiently permeate in the depth direction in the coated layer, it is necessary that the epoxy compound in the coating fluid is sufficiently emulsified. Here, “being sufficiently emulsified”, specifically, indicates that an emulsified substance is stable (emulsion stability is ensured) and an excessive free emulsifier is minimized. Since there is a possibility that the free emulsifier that does not contribute to the emulsification of the epoxy compound bleeds out to the surface or inhibits the crosslinking of the epoxy compound, it is preferable that the free emulsifier is minimized.

That is, in consideration of only coating properties with respect to the surface of the coated layer, it is considered preferable to maximize the amount of emulsified substance in order to decrease the contact angle with respect to the surface of the coated layer, but in order to make the coating properties and the permeableness into the coated layer compatible, it has been found that a suitable amount of stable emulsified substance and no free emulsifier are required.

As a result of further studies, the inventors have found that the coating properties with respect to the surface of the coated layer and the permeableness into the coated layer can be compatible by adjusting each of the content of water in the liquid crosslinking agent and the contact angle with respect to the poly(ethylene-methacrylic acid) film when preparing the coating fluid to be in a specific range. The reason is under consideration, and it is considered that the emulsified state of the epoxy compound in the coating fluid is idealized by having two properties described above.

In addition, the poly(ethylene-methacrylic acid) is a resin having a hydrophobic polyethylene unit and a hydrophilic a methacrylic acid unit having a carboxyl group that is capable of reacting with an epoxy compound. Accordingly, it is considered that the poly(ethylene-methacrylic acid) has the same properties as those of a general coated layer having both hydrophobicity and hydrophilicity, and thus, focusing on this, the poly(ethylene-methacrylic acid) film was set to measurement criteria of the contact angle.

<Contact Angle>

In the liquid crosslinking agent of the invention, the contact angle with respect to the poly(ethylene-methacrylic acid) film when preparing the aqueous dispersion in which the concentration of the non-volatile component is 15% by mass is 42.0° or less.

From the viewpoint of wettability with respect to the surface of the coated layer, the contact angle with respect to the poly(ethylene-methacrylic acid) film (hereinafter, simply referred to as a contact angle) is preferably 40.0° or less, more preferably 39.5° or less, even more preferably 39.0° or less, and particularly preferably 37.0° or less. On the other hand, from the viewpoint of preventing an application defect by suppressing the bleedout of the excessive emulsifier, the contact angle is preferably 20.0° or more, and more preferably 25.0° or more.

The aqueous dispersion in which the concentration of the non-volatile component is 15% by mass can be prepared as described below.

First, the content (the ratio) of the non-volatile component in the liquid crosslinking agent is checked. In a case where a volatile component is not contained in the liquid crosslinking agent, the amount of liquid crosslinking agent indicates the amount of non-volatile component. In a case where the content of the non-volatile component in the liquid crosslinking agent is not clear, the content is checked by heating the liquid crosslinking agent to vaporize water or an organic solvent.

Next, the aqueous dispersion is prepared by adding water to the liquid crosslinking agent such that the content of the non-volatile component is 15% by mass, in consideration of the ratio of the volatile component in the liquid crosslinking agent, and by performing mixing with human power or by performing mixing with a stirrer having a weak stirring force. Here, the aqueous dispersion also includes a case where the non-volatile component is an aqueous solution that is dissolved in water.

Note that, in a case where the liquid crosslinking agent is vaporized to dryness, it may be difficult to form again the liquid crosslinking agent into the aqueous dispersion, and thus, in a case where it is necessary to check the content of the non-volatile component by vaporizing water, the preparation itself of the aqueous dispersion in which the concentration of the non-volatile component is 15% by mass is performed by adding water without drying the liquid crosslinking agent using the liquid crosslinking agent different from that used for checking the content of the non-volatile component.

The contact angle can be measured by a static measurement method according to a drop method using the aqueous dispersion on the interface between the following film and the air.

The poly(ethylene-methacrylic acid) film that is used for the measurement of the contact angle can be prepared as follows.

First, 100 g of a poly(ethylene-methacrylic acid) copolymer (ethylene:methacrylic acid (a copolymerization ratio)=90:10, a radical polymerized product) and 400 g of an isoparaffin-based solvent are put in a planetary mixer (Product Name PLM-2, manufactured by INOUE MFG., INC.) are heated for 1 hour until an internal temperature is 120° C. while stirring at 30 revolution per minute and 90 autorotations per minute, and are stirred for 1.5 hours while retaining the temperature after the internal temperature reaches 120° C. After that, the mixture is continuously stirred while cooling for 4 hours until the internal temperature is 25° C., and thus, a polymer paste is prepared.

Next, 90 g of the polymer paste and 150 g of an isoparaffin-based solvent are put in an attritor (Product Name MA01SC, manufactured by NIPPON COKE & ENGINEERING COMPANY, LIMITED) together with 2 kg of stainless steel beads having a diameter of 5 mm, are heated to an internal temperature of 58° C., are stirred and pulverized at a rotation speed of 30 rpm for 1.5 hours, are further cooled to the internal temperature of 36° C., and are stirred and pulverized for 3.5 hours, and the obtained dispersion liquid is subjected to mesh filtration, and thus, a resin dispersion liquid is prepared.

The obtained resin dispersion liquid is applied onto a biaxially stretched polypropylene film (an abbreviated name of OPP, a film thickness of 20 μm) that is subjected to a corona treatment in advance by using a wire bar, and is dried at 100° C. for 20 minutes, and thus, the poly(ethylene-methacrylic acid) film is prepared.

Note that, the poly(ethylene-methacrylic acid) copolymer may be a radically polymerized product in which ethylene:methacrylic acid (the copolymerization ratio) is 90:10, and a commercially available product can be used as the poly(ethylene-methacrylic acid) copolymer. Examples of the commercially available product include N1050H (manufactured by DOW-MITSUI POLYCHEMICALS CO., LTD.). As the isoparaffin-based solvent, a commercially available product can be used, and examples thereof include ISOPAR L (manufactured by Exxon Mobil Corporation).

In Examples described below, N1050H (manufactured by DOW-MITSUI POLYCHEMICALS CO., LTD.) was used as the poly(ethylene-methacrylic acid) copolymer, and ISOPAR L (manufactured by Exxon Mobil Corporation) was used as the isoparaffin-based solvent.

Hereinafter, the poly(ethylene-methacrylic acid) film prepared by the method described above may be referred to as a “specific poly(ethylene-methacrylic acid) film”.

<Average Particle Diameter of Epoxy Compound>

It is preferable that the liquid crosslinking agent of the invention has properties that an average particle diameter of the epoxy compound is 1 μm or less when simply diluted with water. Here, the simple dilution indicates an operation of adding water to the liquid crosslinking agent such that the content of the non-volatile component is 15% by mass, and of shaking the liquid crosslinking agent for 1 minute with human power or with a weak stirring force of a simple shaker or the like.

The average particle diameter of the epoxy compound is more preferably 0.8 μm or less, and even more preferably 0.5 μm or less. Note that, from the viewpoint of the stability of the epoxy compound, it is preferable that the average particle diameter of the epoxy compound is 0.05 μm or more.

The average particle diameter of the epoxy compound is a volume average particle diameter obtained from a particle size distribution that is measured by a dynamic light scattering device immediately after simply diluting the liquid crosslinking agent.

Note that, it is preferable that the average particle diameter of the epoxy compound is in the numerical range described above even in the case of being measured by the method described above one week after the liquid crosslinking agent is simply diluted. Further, it is preferable that both of the average particle diameter immediately after the simple dilution and the average particle diameter one week after the simple dilution are 0.5 μm or less.

<Epoxy Compound>

As the epoxy compound of the invention, various known epoxy compounds can be used, a molecular structure, a molecular weight, and the like thereof are not particularly limited insofar as the epoxy compound has an epoxy group in molecules, and any of a monomer, an oligomer, and a polymer can be used. The number of epoxy groups in molecules is preferably 2 or more, and is more preferably 2, from the viewpoint of intermolecular crosslinking properties.

Examples of the epoxy compound include a bisphenol A type epoxy compound, a hydrogenated bisphenol A type epoxy compound, a bisphenol F type epoxy compound, a hydrogenated bisphenol F type epoxy compound, a phenol novolac type epoxy compound, a cresol novolac type epoxy compound, an alkylene oxide type epoxy compound, an alicyclic epoxy compound, alkyl diglycidyl ether, polypropylene glycol diglycidyl ether, diglycidyl orthophthalate, epoxidized soybean oil, and the like. Among them, the hydrogenated bisphenol A type epoxy compound, the alkylene oxide type epoxy compound, the alicyclic epoxy compound, the alkyl diglycidyl ether, the polypropylene glycol diglycidyl ether, the diglycidyl orthophthalate, and the epoxidized soybean oil are preferable, and the alkyl diglycidyl ether and the polypropylene glycol diglycidyl ether are more preferable. Further, the epoxy compounds having less impurities or hydrolyzable chlorine are more preferable. Two or more types of epoxy compounds may be used together.

Examples of the epoxy compound include a water-soluble epoxy compound and a dispersive epoxy compound, and the dispersive epoxy compound is preferable from the viewpoint of a time-dependent change after the dilution with water during coating. Here, “dispersive” indicates water dispersibility, that is, suspensibility, and indicates water insolubility. Note that, there is also a document in which some of the epoxy compounds exemplified as described above are water-soluble (for example, refer to JP H5-202333 A), but the epoxy compounds are formed into micromicelles having a submicrometer size, and are not actually dissolved in water even though appearing as a transparent aqueous solution, and thus, in the invention, the epoxy compounds are sorted into a dispersion liquid.

<Curing Agent>

The liquid crosslinking agent of the invention can be used together with a curing agent having a curing accelerative effect of the epoxy compound. Examples of the curing agent include an amine-based curing agent such as aliphatic amine, alicyclic amine, and aromatic amine, an acid anhydride-based curing agent, a catalytic curing agent such as 2-ethyl-4-methyl imidazole, a tertiary amine/imidazole-based curing agent, and a latent curing agent such as dicyandiamide and organic acid dihydrazide. Two or more types of the curing agents may be used together.

Such curing agents can be used by being mixed in advance in the liquid crosslinking agent of the invention, or by being mixed immediately before diluting the liquid crosslinking agent of the invention to be the coating fluid of the liquid crosslinking agent, and from the viewpoint of pot life, it is preferable that the curing agent is mixed immediately before preparing the coating fluid. Note that, in the invention, a main mechanism is to cause a crosslinking reaction between the liquid crosslinking agent and a printing layer applied or impregnated with the liquid crosslinking agent or other coating fluid components, and thus, the curing agent is supplementarily used for the main mechanism.

<Emulsifier>

The emulsifier of the invention has a function of dispersing the epoxy compound as a stable emulsion when producing the coating fluid of the liquid crosslinking agent by diluting the liquid crosslinking agent of the invention with water. Note that, the emulsifier also has a function of stably dispersing the epoxy compound even in the liquid crosslinking agent in a case where the liquid crosslinking agent of the invention contains water.

The emulsifier of the invention is not particularly limited insofar as the emulsifier is capable of emulsifying the epoxy compound, and examples thereof include an anionic surfactant such as a sulfate of higher alcohol, an alkyl benzene sulfonate, a polyoxyethylene alkyl sulfate, a polyoxypropylene alkyl sulfate, a polyoxyethylene alkyl phenol ether sulfate, and a polyoxypropylene alkyl phenol ether sulfate; a nonionic surfactant such as polyoxyethylene polyalkylene ether and polyoxypropylene polyalkylene ether such as P123 (manufactured by Sigma-Aldrich Co. LLC), polyoxyethylene alkyl phenol ether and polyoxypropylene alkyl phenol ether such as NOIGEN EA177D and NOIGEN EA207D (all are manufactured by DKS Co. Ltd.), an ethylene oxide propylene oxide block polymer, and a sorbitan derivative; a so-called reactive emulsifier such as acrylic acid ester of trimethylol propane, and alkenyl monoallyl succinate, and the like.

Among the emulsifiers exemplified as described above, the nonionic surfactant is preferable from the viewpoint of dispersion stability, and among them, a polyoxyethylene-based compound and a polyoxypropylene-based compound are more preferable, and the polyoxyethylene polyalkylene ether and the polyoxyethylene alkyl phenol ether are even more preferable.

In addition, in the nonionic surfactant, a HLB value is preferably 8 or more, and more preferably 10 or more, whereas is preferably 20 or less, and more preferably 19 or less. In a case where the HLB value is 8 or more, the hydrophilicity of the nonionic surfactant is high, and thus, a stabilization effect of particles during dispersion and after dispersion is strong, and an excellent dispersion liquid can be obtained. In addition, in a case where the HLB value is 20 or less, the hydrophilicity of the surfactant is not excessively high, and thus, a coating film that is obtained from the coating fluid blended with the dispersion liquid has excellent water resistance.

It is preferable that a number average molecular weight of the emulsifier is 600 or more and 4000 or less. In a case where the number average molecular weight is 600 or more or 4000 or less, an excellent dispersion liquid can be obtained.

One type of the emulsifiers may be used, or two or more types thereof may be used together. In particular, in order to improve the coating properties and the permeableness of the liquid crosslinking agent, it is preferable to use together an emulsifier selected from a specific compound group of the emulsifier and an emulsifier that is not included in the specific compound group. The details of the specific compound group will be described below as a permeation enhancer.

<Permeation Enhancer>

In order to aid homogeneous coating of the epoxy compound and to accelerate the permeation of the epoxy compound into the coating surface, the liquid crosslinking agent of the invention may further contain a permeation enhancer as described above. In the case of containing the permeation enhancer, the emulsification and the permeation acceleration are performed in a balanced manner during coating, and a coating failure such as coating unevenness can be suppressed.

It is necessary that the permeation enhancer does not inhibit the emulsification of the epoxy compound in the state of the liquid crosslinking agent or the coating fluid of the liquid crosslinking agent described below. Specifically, it is necessary that the permeation enhancer does not affect the emulsified state of the epoxy compound, and does not cause demulsification, aggregation, precipitation, and the like.

Further, it is necessary that the permeation enhancer improves the wettability after coating and accelerate the permeation to the coating surface. In particular, both the wettability and the permeableness are required when coating on a base having a high in-plane fluctuation in the permeableness.

Accordingly, the permeation enhancer of the invention may be any compound corresponding to the properties described above among compounds that are also generally used in the emulsifier and have the effect as the surfactant. In other words, it is indicated that a specific emulsifier is used as the permeation enhancer together with an emulsifier that is not contained in the permeation enhancer.

Specifically, an anionic surfactant, a cationic surfactant, and a nonionic surfactant can be used as the permeation enhancer. Among them, the nonionic surfactant is preferable from the viewpoint of the stability of an application liquid.

Examples of a preferred nonionic surfactant may include polyethylene glycol fatty acid ester, sorbitan fatty acid ester, sorbitol fatty acid ester, glycerin fatty acid ester, pentaerythritol fatty acid ester, POE acetylene glycols, tetraPOE/tetraPOP ethylene diamine condensates, and the like.

Note that, in the above exemplification and the following description, “POE” is an abbreviation for “polyoxyethylene”, and “POP” is an abbreviation for “polyoxypropylene”.

Such nonionic surfactants can be used alone or two or more types thereof may be used in combination.

Among them, the POE acetylene glycols and the tetraPOE/tetraPOP ethylene diamine condensates can be more preferably used, and in particular, the POE acetylene glycols can be most preferably used, from the viewpoint of excellent stability of the liquid crosslinking agent or the coating fluid of the liquid crosslinking agent described below after dispersion.

Examples of a commercially available product of the POE acetylene glycols may include SURFYNOL (Registered Trademark, manufactured by Nissin Chemical co., ltd.) and the like. Examples of a commercially available product of the tetraPOE/tetraPOP ethylene diamine condensates may include Pluronic (Registered Trademark, manufactured by BASF SE), Tetronic (Registered Trademark, manufactured by BASF SE), and the like.

It is preferable that a number average molecular weight of the permeation enhancer is 400 or more and 3000 or less. In a case where the number average molecular weight is 400 or more or 3000 or less, excellent permeableness can be obtained without impairing the emulsification of the epoxy compound.

<Combination of Emulsifier and Permeation Enhancer>

A preferred combination of the emulsifier and the permeation enhancer is not limited, but it is preferable to use a nonionic surfactant for both of the emulsifier and the permeation enhancer. For example, it is preferable that a polyoxyethylene-based compound or a polyoxypropylene-based compound is used as the emulsifier, and POE acetylene glycols, tetraPOE/tetraPOP ethylene diamine condensates, and the like are used as the permeation enhancer. Here, the polyoxyethylene-based compound or the polyoxypropylene-based compound indicates polyether of which the terminal or the side chain is not modified.

<Content of Emulsifier and Permeation Enhancer>

The content of the emulsifier of the liquid crosslinking agent of the invention is generally 2 parts by mass or more, preferably 5 parts by mass or more, and more preferably 10 parts by mass or more, with respect to 100 parts by mass of the epoxy compound. In addition, the content is generally 50 parts by mass or less, preferably 40 parts by mass or less, and more preferably 25 parts by mass or less. In a case where the content of the emulsifier is the lower limit value or more, the dispersion stability of the epoxy compound is improved, and in a case where the content is the upper limit value or less, it is possible to prevent the emulsifier from bleeding out to the surface after coating or from being concentrated on the interface between the coating layer and the substrate to degrade the adhesiveness.

In a case where the emulsifier and the permeation enhancer are used together, a preferred total content of the emulsifier and the permeation enhancer is the same as a preferred content of the emulsifier.

For the ratio of the emulsifier and the permeation enhancer, in order for the permeation enhancer not to inhibit an emulsification effect of the emulsifier, it is preferable that the amount of permeation enhancer is less than the amount of emulsifier. In this case, the content of the permeation enhancer is generally 0.1 parts by mass or more, preferably 0.5 parts by mass or more, and more preferably 1 part by mass or more, with respect to 100 parts by mass of the epoxy compound. In addition, the content is generally 30 parts by mass or less, preferably 20 parts by mass or less, and more preferably 15 parts by mass or less. In a case where the content of the permeation enhancer is the lower limit value or more, the applicability and the permeableness are improved, and in a case where the content is the upper limit value or less, it is possible to prevent the permeation enhancer from bleeding out to the surface after coating or from being concentrated on the interface between the coating layer and the substrate to degrade the adhesiveness.

<Water>

In the liquid crosslinking agent of the invention, the content of water is 39% by mass or less with respect to the total amount of the liquid. In a case where the content of water is 39% by mass or less, it is possible to prevent the epoxy compound from being gradually decomposed due to a reaction with water when storing the liquid crosslinking agent to degrade crosslinking performance during coating.

The content of water is preferably 20% by mass or less, more preferably 5% by mass or less, even more preferably 1% by mass or less, particularly preferably 0.1% by mass or less, and most preferably 0% by mass, with respect to the total amount of the liquid, that is, it is most preferable that water is not contained. Here, the “total amount of the liquid” indicates the total amount of the liquid crosslinking agent.

<Organic Solvent>

In the liquid crosslinking agent of the invention, an organic solvent such as alcohol, glycol, and ether can also be contained, but it is preferable that the organic solvent is not contained from the viewpoint of maintaining a working environment, of preventing atmospheric pollution, and of eliminating the need for a solvent treatment apparatus. Specifically, the content of the organic solvent is preferably 10% by mass or less, more preferably 5% by mass or less, even more preferably 2% by mass or less, particularly preferably 0.1% by mass or less, and most preferably 0% by mass, with respect to the total amount of the liquid of the liquid crosslinking agent, that is, it is most preferable that the organic solvent is not contained.

<State>

The liquid crosslinking agent of the invention is liquid at an ordinary temperature (23° C.). Here, in a case where the content of water is low (0% by mass), and the content of the organic solvent is also low (0% by mass), substantially, the main component of the liquid crosslinking agent is the epoxy compound. Accordingly, it is preferable that the epoxy compound is liquid at the ordinary temperature (23° C.). Further, it is preferable that the permeation enhancer is also liquid, water-soluble, or water-dispersible at the ordinary temperature (23° C.), and it is preferable that the emulsifier is also liquid, water-soluble, or water-dispersible at the ordinary temperature (23° C.). In addition, even though a single compound is solid at the ordinary temperature (23° C.), a mixture obtained by mixing a plurality of solid compounds can be liquid at the ordinary temperature (23° C.)

<Other Components>

Note that, liquid crosslinking agent of the invention may contain known additives such as an antioxidant, an ultraviolet absorber, a lubricant, colorant, a mildew-proofing agent, a brightener (a gloss agent), and a delusterant (a matting agent), as necessary.

<Method for Producing Liquid Crosslinking Agent>

A method for producing the liquid crosslinking agent of the invention is not limited. Specifically, examples of the method include the following two methods.

(Case where Water is not Contained in Liquid Crosslinking Agent)

The epoxy compound, the emulsifier, and other components that are used as necessary are mixed in an arbitrary order, are stirred and mixed at a room temperature of approximately 25° C., and thus, it is possible to produce the liquid crosslinking agent that is approximately homogeneously mixed. When stirring and mixing, a stirring speed is not particularly limited, and a stirring time is generally 5 minutes or longer, and preferably 10 minutes or longer.

(Case where Water is Contained in Liquid Crosslinking Agent)

In a case where water is contained in the liquid crosslinking agent, in order to ensure storage stability of the epoxy compound, it is preferable to form an emulsion state of a sea-island structure in which water is the sea and the epoxy compound is the island. Each material may be mixed in an arbitrary order, or all the materials may be simultaneously mixed.

In a case where the permeation enhancer is further contained, from the viewpoint of forming a stable emulsion, it is preferable that the epoxy compound and the emulsifier are mixed first, and then, a small amount of water is added while stirring, phase transition is performed while heating to approximately 40 to 50° C., and then, the permeation enhancer is added.

In addition, in order to form a stable emulsion, it is preferable that the viscosity of the epoxy compound and the viscosity of the emulsifier are close to each other. Other arbitrary components may be mixed at any stage.

[Coating Fluid of Liquid Crosslinking Agent]

The purpose and the method of using the liquid crosslinking agent of the invention are not limited, but in general, the liquid crosslinking agent is transported and stored as an undiluted coating solution. In the state of the undiluted coating solution, viscosity is high, and the coating properties and the permeableness are not sufficient as it is, and thus, the undiluted coating solution is used as the coating fluid of the liquid crosslinking agent by being diluted with water immediately before coating or within a time in which a time-dependent change in the coating fluid is allowed such that the concentration of the non-volatile component is suitable for coating. It is preferable that a dilution factor with water is 5 times or more and 20 times or less. In addition, it is preferable that the concentration of the non-volatile component of the coating fluid of the liquid crosslinking agent is 10% by mass or more and 30% by mass or less.

It is also possible to produce the coating fluid by mixing and dispersing each raw material immediately before coating without using the undiluted coating solution, that is, to produce the liquid crosslinking agent as the coating fluid of the liquid crosslinking agent from the start, but in order for this, a dispersion treatment facility for the coating fluid is required. Accordingly, it is preferable that the liquid crosslinking agent of the invention is used as the coating fluid of the liquid crosslinking agent by being diluted immediately before coating or within a time in which the time-dependent change in the coating fluid is allowed.

Since the liquid crosslinking agent of the invention has long pot life, a special facility such as a coating fluid storage facility at a low temperature and an organic solvent treatment facility is not required. In addition, the liquid crosslinking agent of the invention has a high content ratio of the non-volatile component, and thus, can be more compactly stored.

[Method for Producing Coating Fluid of Liquid Crosslinking Agent]

When preparing the coating fluid of the liquid crosslinking agent by diluting the liquid crosslinking agent of the invention, water is added to the liquid crosslinking agent and is stirred. In this case, stirring with a homogenizer, a homomixer, or a stirring blade, or a dispersion method such as an ultrasonic wave or a high-pressure liquid collision can also be used, and simple dilution is preferable from the viewpoint of workability and from the viewpoint of a load for supporting a facility. The major characteristics of the liquid crosslinking agent of the invention can be easily mixed and dispersed without using a large-scale equipment or apparatus when preparing the coating fluid of the liquid crosslinking agent. Here, the simple dilution indicates a dilution operation of shaking a container in which the liquid crosslinking agent and water to be used for dilution are put for a short period of time within 1 minute, with human power or a weak stirring force of a simple shaker or the like without using the apparatus for stirring or dispersion described above when diluting the liquid crosslinking agent with water to have a concentration suitable for coating. Accordingly, a microemulsion or a micromicelle is formed, which is preferable from the viewpoint of time-dependent stability of the epoxy compound and the permeableness after coating.

The average particle diameter of the epoxy compound in the coating fluid of the liquid crosslinking agent that is simply diluted with water is preferably 1 μm or less, more preferably 0.8 μm or less, and most preferably 0.5 μm or less, from the viewpoint of the dispersion stability, the wettability, and the permeableness. Here, the average particle diameter indicates a volume average particle diameter obtained by a particle diameter measurement device according to a dynamic light scattering method for measuring a fluctuation in scattering light due to a Brownian motion of the particles.

[Coating Method]

The coating fluid of the liquid crosslinking agent of the invention is coated on a coating layer or a printing layer of a substrate in which the coating layer or the printing layer is formed in advance on the surface, and is heated to crosslink and cure the coating layer or the printing layer, and thus, can be used for improving heat resistance, water resistance, mechanical strength, and the like of the coating layer or the printing layer. Here, the use application of the coating fluid of the liquid crosslinking agent of the invention is not limited to such a usage.

As the substrate to be coated or printed, a metal substrate such as aluminum, nickel, stainless steel, steel, and magnesium, and a flexible substrate such as polyethylene, polypropylene, polyethylene terephthalate, polyethylene naphthalate, polyamide, polyurethane, polyvinyl chloride, and a thermoplastic elastomer are used, and glass, paper, a natural material, or the like may be used. In the case of the flexible substrate, a stretched body, a porous body, a foamed body, or the like may be used. In addition, paper coated with a resin such as polyethylene-coated paper can also be used.

One layer or two or more layers may be coated or printed on the substrate. A film thickness of the coating layer or the printing layer is generally 0.1 μm to 10 μm.

The coating layer or the printing layer is not limited, but in general, is a layer containing a resin reacting with the epoxy compound, and the coating fluid of the liquid crosslinking agent of the invention is preferably used for a layer using a resin having a hydroxyl group, a thiol group, amino group, a carboxy group, an acid anhydride group, or the like. Examples of the resin include polyvinyl alcohol, an ethylene/vinyl alcohol copolymer, polyvinyl butyral, polyamine, polyethylene imine, an ethylene/acrylic acid copolymer, an ethylene/methacrylic acid copolymer, a denatured-maleic anhydride of polyethylene or polypropylene, polyethylene terephthalate or polyarylate, and the like. In general, the polyethylene terephthalate or the polyarylate has a hydroxyl group or a carboxyl group on the terminal of a polymer chain, and among them, a resin having a higher acid value is preferable.

Among the resins described above, a resin having properties of being impregnated with water. In a case where the layer to be coated or printed contains the resin to be impregnated with water, the coating fluid of the liquid crosslinking agent of the invention has excellent permeableness. Note that, the resin having the properties of being impregnated with water includes a resin having a porous structure even in a case where the resin itself does not contain water, a resin modified or denatured with the functional groups exemplified as described above, or the like.

Examples of a method for forming the coating layer on the substrate include painting using a spray, a roller, a brush, or the like.

Examples of the method for forming the printing layer on the substrate include analog printing such as offset printing, gravure printing, flexographic printing, and screen printing, and digital printing such as electrophotographic printing and inkjet printing.

The printing layer may be further provided on the coating layer on the substrate, the coating layer may be further provided on the printing layer on the substrate, a second coating layer may be provided on the coating layer on the substrate, or a second printing layer may be further provided on the printing layer on the substrate. As described above, in a case where two or more coating layers and/or printing layers are provided, it is necessary that the coating fluid of the liquid crosslinking agent of the invention permeates at least the uppermost layer to be crosslinked, and it is preferable that the coating fluid permeates all the layers to be crosslinked.

A coating method of the coating fluid of the liquid crosslinking agent to the coating layer or the printing layer on the substrate is not particularly limited, and examples thereof include a die coating method, a gravure coating method, a reverse gravure coating method, a microreverse gravure coating method, a screen coating method, a spray coating method, and the like.

By diluting the coating fluid of the liquid crosslinking agent of the invention with water, the epoxy compound is dispersed into fine oil droplets by the function of the emulsifier, and the viscosity of the coating fluid moderately decreases, and thus, the permeableness to coating layer or the printing layer on the substrate is accelerated. It is assumed that in a case where the epoxy compound is in the shape of a fine oil droplet, the fine oil droplet is accelerated to enter the gap of the resin in the coating layer or the printing layer on the substrate, and thus, the layer can be impregnated with the coating fluid.

Next, the substrate including the coating layer or the printing layer, which is coated with the coating fluid of the liquid crosslinking agent, is heated to dry the coating film of the coating fluid of the liquid crosslinking agent. According to such heating, the reaction of the epoxy compound is accelerated. A heating temperature is preferably 60° C. or higher, more preferably 80° C. or higher, and most preferably 100° C. or higher. An upper limit of the heating temperature is not particularly limited unless other contained materials are denatured or deformation such as shrinkage and bentness occur in materials to be used for the substrate, and in general, the upper limit is preferably 150° C. or lower, and more preferably 130° C. or lower.

A drying time is different in accordance with a heating temperature for drying or drying means, but is preferably 1 minute or longer, and more preferably 5 minutes or longer, whereas is preferably 1 hour or shorter, and more preferably 30 minutes or shorter, from the viewpoint of curing properties and productivity.

Note that, the drying temperature may be gradually changed. As an example of two-step heating, ring-opening of an epoxy ring can be accelerated by drying at a comparatively high temperature for a short period of time (first drying), and then, a reaction between the ring-opened epoxy ring and the coating layer or the printing layer on the substrate can be performed by drying at a comparatively low temperature for a long period of time (second drying). In this case, the first drying temperature is preferably 60° C. or higher, and more preferably 70° C. or higher, from the viewpoint of the curing properties and the productivity. On the other hand, the first drying temperature is preferably 100° C. or lower, and more preferably 90° C. or lower, from the viewpoint of preventing foam formation. The first drying time is different in accordance with heating means or a heating temperature, and in the case of blast heating, the first drying time is preferably 20 minutes or shorter, and more preferably 10 minutes or shorter, from the viewpoint of the productivity and the suppression of the deformation of the substrate, and preferably 1 minute or longer, and more preferably 2 minutes or longer, from the viewpoint of reactivity.

In addition, the second drying temperature is preferably 150° C. or lower, and more preferably 130° C. or lower, from the viewpoint of suppressing the deformation of the substrate. On the other hand, the second drying temperature is preferably 110° C. or higher, and more preferably 120° C. or higher, from the viewpoint of the curing properties and the productivity. The second drying time is different in accordance with the heating means or the heating temperature, and in the case of the blast heating, the second drying time is preferably 30 minutes or shorter, and more preferably 20 minutes or shorter, from the viewpoint of the productivity and the suppression of the deformation of the substrate, and preferably 1 minute or longer, and more preferably 5 minutes or longer, from the viewpoint of the curing properties.

Note that, in addition to the drying step immediately after coating described above, warming (aging) may be performed with an oven or the like at a temperature lower than the drying temperature for a long period of time. In this case, the temperature is generally 40° C. or higher, and preferably 50° C. or higher, from the viewpoint of terminating the curing properties, whereas is generally 70° C. or lower, and preferably 60° C. or lower, from the viewpoint of preventing sticking (blocking) in the case of stacking the coating layer or the printing layer. It is preferable that a warming (aging) time is 12 hours or longer and 72 hours or shorter.

As the heating/drying means, blast heating, infrared heating, exposure heating using a halogen lamp, a xenon flash tube, or the like, IH heating, and the like can be used.

A coating amount (the mass of the non-volatile component after drying) of the coating fluid of the liquid crosslinking agent of the invention depends on the thickness of the coating layer or the printing layer to be coated, and thus, may not be generalized, but is generally 0.1 g/m² or more and 5 g/m² or less, and preferably 0.3 g/m² or more and 2 g/m² or less, from the viewpoint of the curing properties and the prevention of the excess crosslinking agent on the coating surface.

### EXAMPLES

Hereinafter, the embodiment of the invention will be described in more detail by Examples. Here, Examples described below are represented to describe the invention in detail, but the invention is not limited to Examples described below and can be arbitrarily modified without departing from the gist thereof.

### Example 1

<Production of Liquid Crosslinking Agent 1 and Coating Fluid 1 of Liquid Crosslinking Agent>180 g of a hydrogenated bisphenol A type epoxy resin YX8034 (manufactured by Mitsubishi Chemical Corporation, Number of Epoxy Groups in Molecules: 2 or more), 420 g of alkyl diglycidyl ether YED216D (manufactured by Mitsubishi Chemical Corporation, Number of Epoxy Groups in Molecules: 2), 100 g of a POE/POP-based emulsifier P123 (manufactured by Sigma-Aldrich Co. LLC) represented in Formula (1) described below, and 60 g of POE acetylene glycol-based SURFYNOL 465 (manufactured by Nissin Chemical co., ltd.) represented in Formula (2) described below as a permeation enhancer were added, and were stirred at a room temperature for 10 minutes, and thus, 760 g of an undiluted solution of a liquid crosslinking agent 1 not containing water was obtained.

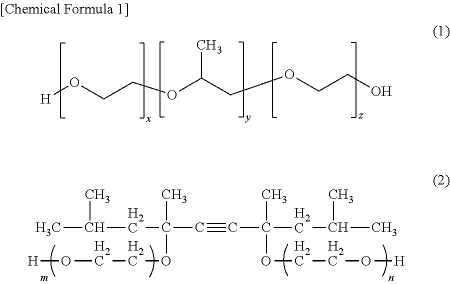

The undiluted solution was transported and stored in a storage container, water was added immediately before coating, and the container was shaken with a hand for 1 minute, and thus, the undiluted solution was diluted such that the concentration of a non-volatile component was 15% by mass, and a coating fluid 1 of the liquid crosslinking agent was obtained.

### Example 2

<Production of Liquid Crosslinking Agent 2 and Coating Fluid 2 of Liquid Crosslinking Agent>

180 g of a hydrogenated bisphenol A type epoxy resin YX8034 (manufactured by Mitsubishi Chemical Corporation), 420 g of alkyl diglycidyl ether YED216D (manufactured by Mitsubishi Chemical Corporation), 190 g of water, 100 g of a POE/POP-based emulsifier P123 (manufactured by Sigma-Aldrich Co. LLC) represented in Formula (1) described above, and 60 g of POE acetylene glycol-based SURFYNOL 465 (manufactured by Nissin Chemical co., ltd.) represented in Formula (2) described above as a permeation enhancer were added, and were stirred at a room temperature for 10 minutes, and thus, 950 g of an undiluted solution of a liquid crosslinking agent 2 in which the concentration of a non-volatile component was 80% by mass was obtained.

The undiluted solution was transported and stored in a storage container, water was added immediately before coating, and the container was shaken with a hand for 1 minute, and thus, the undiluted solution was diluted such that the concentration of the non-volatile component was 15% by mass, and a coating fluid 2 of the liquid crosslinking agent was obtained.

### Example 3

<Production of Liquid Crosslinking Agent 3 and Coating Fluid 3 of Liquid Crosslinking Agent>

180 g of a hydrogenated bisphenol A type epoxy resin YX8034 (manufactured by Mitsubishi Chemical Corporation), 420 g of alkyl diglycidyl ether YED216D (manufactured by Mitsubishi Chemical Corporation), 466 g of water, 100 g of a POE/POP-based emulsifier P123 (manufactured by Sigma-Aldrich Co. LLC) represented in Formula (1) described above, and 60 g of POE acetylene glycol-based SURFYNOL 465 (manufactured by Nissin Chemical co., ltd.) represented in Formula (2) described above as a permeation enhancer were added, and were stirred at a room temperature for 10 minutes, and thus, 1226 g of an undiluted solution of a liquid crosslinking agent 3 in which the concentration of a non-volatile component was 62% by mass was obtained.

The undiluted solution was transported and stored in a storage container, water was added immediately before coating, and the container was shaken with a hand for 1 minute, and thus, the undiluted solution was diluted such that the concentration of the non-volatile component was 15% by mass, and a coating fluid 3 of the liquid crosslinking agent was obtained.

### Example 4

<Production of Liquid Crosslinking Agent 4 and Coating Fluid 4 of Liquid Crosslinking Agent>

180 g of a hydrogenated bisphenol A type epoxy resin YX8034 (manufactured by Mitsubishi Chemical Corporation), 420 g of alkyl diglycidyl ether YED216D (manufactured by Mitsubishi Chemical Corporation), 150 g of NOIGEN EA177D (manufactured by DKS Co. Ltd.) represented in Formula (3) described below as an emulsifier, and 60 g of POE acetylene glycol-based SURFYNOL 465 (manufactured by Nissin Chemical co., ltd.) represented in Formula (2) described above as a permeation enhancer were added, and were stirred at a room temperature for 10 minutes, and thus, 810 g of an undiluted solution of a liquid crosslinking agent 4 not containing water was obtained.

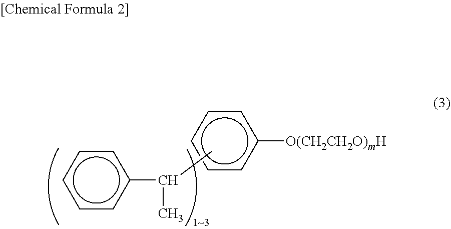

The undiluted solution was transported and stored in a storage container, water was added immediately before coating, and the container was shaken with a hand for 1 minute, and thus, the undiluted solution was diluted such that the concentration of the non-volatile component was 15% by mass, and a coating fluid 4 of the liquid crosslinking agent was obtained.

### Example 5

<Production of Liquid Crosslinking Agent 5 and Coating Fluid 5 of Liquid Crosslinking Agent>

600 g of alkyl diglycidyl ether YED216D (manufactured by Mitsubishi Chemical Corporation), 48 g of a POE/POP-based emulsifier P123 (manufactured by Sigma-Aldrich Co. LLC) represented in Formula (1) described above, and 30 g of POE acetylene glycol-based SURFYNOL 465 (manufactured by Nissin Chemical co., ltd.) represented in Formula (2) described above as a permeation enhancer were added, and were stirred at a room temperature for 10 minutes, and thus, 678 g of an undiluted solution of a liquid crosslinking agent 5 not containing water was obtained.

The undiluted solution was transported and stored in a storage container, water was added immediately before coating, and the container was shaken with a hand for 1 minute, and thus, the undiluted solution was diluted such that the concentration of the non-volatile component was 15% by mass, and a coating fluid 5 of the liquid crosslinking agent was obtained.

### Example 6

<Production of Liquid Crosslinking Agent 6 and Coating Fluid 6 of Liquid Crosslinking Agent>

194 g of a hydrogenated bisphenol A type epoxy resin YX8034 (manufactured by Mitsubishi Chemical Corporation), 453 g of alkyl diglycidyl ether YED216D (manufactured by Mitsubishi Chemical Corporation), and 131 g of NOIGEN EA207D (manufactured by DKS Co. Ltd.) represented in Formula (4) described below as an emulsifier (the concentration of a non-volatile component of 55% by mass, and water of 45% by mass) were put in a three-neck flask of 2 L, were warmed to 40° C. while stirring at 50 rpm, and were stirred for 30 minutes by adding 49 g of ordinary-temperature water to cause phase transition. After that, 372 g of ordinary temperature water was further added at a rotation speed of 250 rpm, warming was performed such that a liquid temperature was increased up to 80° C., and then, cooling was performed at a room temperature, and 65 g of POE acetylene glycol-based SURFYNOL 465 (manufactured by Nissin Chemical co., ltd.) represented in Formula (2) described above as a permeation enhancer was added, and thus, 1265 g of an undiluted solution of a liquid crosslinking agent 6 in which the concentration of a non-volatile component was 62% by mass was obtained.

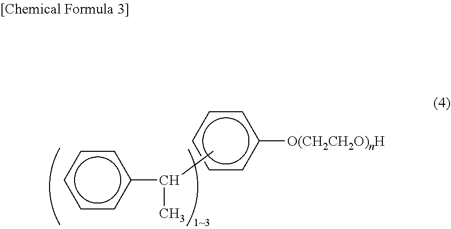

The undiluted solution was transported and stored in a storage container, water was added immediately before coating, and the container was shaken with a hand for 1 minute, and thus, the undiluted solution was diluted such that the concentration of the non-volatile component was 15% by mass, and a coating fluid 6 of the liquid crosslinking agent was obtained.

### Example 7

<Production of Liquid Crosslinking Agent 7 and Coating Fluid 7 of Liquid Crosslinking Agent>

A liquid crosslinking agent 7 and a coating fluid 7 of the liquid crosslinking agent were obtained as with the production of the liquid crosslinking agent 1 and the coating fluid 1 of the liquid crosslinking agent except that the permeation enhancer was not used.

### Example 8

<Production of Liquid Crosslinking Agent 8 and Coating Fluid 8 of Liquid Crosslinking Agent>

600 g of polypropylene glycol diglycidyl ether DENACOL EX-920 (manufactured by Nagase ChemteX Corporation, Number of Epoxy Groups in Molecules: 2), 48 g of a POE/POP-based emulsifier P123 (manufactured by Sigma-Aldrich Co. LLC) represented in Formula (1) described above, and 30 g of POE acetylene glycol-based SURFYNOL 465 (manufactured by Nissin Chemical co., ltd.) represented in Formula (2) described above as a permeation enhancer were added, and were stirred at a room temperature for 10 minutes, and thus, 678 g of an undiluted solution of a liquid crosslinking agent 8 not containing water was obtained.

The undiluted solution was transported and stored in a storage container, water was added immediately before coating, and the container was shaken with a hand for 1 minute, and thus, the undiluted solution was diluted such that the concentration of the non-volatile component was 15% by mass, and a coating fluid 8 of the liquid crosslinking agent was obtained.

### Example 9

<Production of Liquid Crosslinking Agent 9 and Coating Fluid 9 of Liquid Crosslinking Agent>

600 g of diglycidyl orthophthalate DENACOL EX-721 (manufactured by Nagase ChemteX Corporation, Number of Epoxy Groups in Molecules: 2), 48 g of a POE/POP-based emulsifier P123 (manufactured by Sigma-Aldrich Co. LLC) represented in Formula (1) described above, and 30 g of POE acetylene glycol-based SURFYNOL 465 (manufactured by Nissin Chemical co., ltd.) represented in Formula (2) described above as a permeation enhancer were added, and were stirred at a room temperature for 10 minutes, and thus, 678 g of an undiluted solution of a liquid crosslinking agent 9 not containing water was obtained.

The undiluted solution was transported and stored in a storage container, water was added immediately before coating, and the container was shaken with a hand for 1 minute, and thus, the undiluted solution was diluted such that the concentration of the non-volatile component was 15% by mass, and a coating fluid 9 of the liquid crosslinking agent was obtained.

### Example 10

<Production of Liquid Crosslinking Agent 10 and Coating Fluid 10 of Liquid Crosslinking Agent>

600 g of epoxidized soybean oil ADK CIZER O-130P (manufactured by ADEKA CORPORATION, Number of Epoxy Groups in Molecules: 2 or more), 48 g of a POE/POP-based emulsifier P123 (manufactured by Sigma-Aldrich Co. LLC) represented in Formula (1) described above, and 30 g of POE acetylene glycol-based SURFYNOL 465 (manufactured by Nissin Chemical co., ltd.) represented in Formula (2) described above as a permeation enhancer were added, and were stirred at a room temperature for 10 minutes, and thus, 678 g of an undiluted solution of a liquid crosslinking agent 10 not containing water was obtained.

The undiluted solution was transported and stored in a storage container, water was added immediately before coating, and the container was shaken with a hand for 1 minute, and thus, the undiluted solution was diluted such that the concentration of the non-volatile component was 15% by mass, and a coating fluid 10 of the liquid crosslinking agent was obtained.

### Comparative Example 1

<Production of Comparative Liquid Crosslinking Agent 1 and Comparative Coating Fluid 1 of Liquid Crosslinking Agent>

180 g of a hydrogenated bisphenol A type epoxy resin YX8034 (manufactured by Mitsubishi Chemical Corporation), 420 g of alkyl diglycidyl ether YED216D (manufactured by Mitsubishi Chemical Corporation), water 480 g, 60 g of a POE/POP-based emulsifier P123 (manufactured by Sigma-Aldrich Co. LLC) represented in Formula (1) described above, and 60 g of POE acetylene glycol-based SURFYNOL 465 (manufactured by Nissin Chemical co., ltd.) represented in Formula (2) described above as a permeation enhancer were added, and were stirred at a room temperature for 10 minutes, and thus, 1200 g of an undiluted solution of a comparative liquid crosslinking agent 1 in which the concentration of a non-volatile component was 60% by mass was obtained.

The undiluted solution was transported and stored in a storage container, water was added immediately before coating, and the container was shaken with a hand for 1 minute, and thus, the undiluted solution was diluted such that the concentration of the non-volatile component was 15% by mass, and a comparative coating fluid 1 of the liquid crosslinking agent was obtained.

### Comparative Example 2

<Production of Comparative Liquid Crosslinking Agent 2 and Comparative Coating Fluid 2 of Liquid Crosslinking Agent>

600 g of alkyl diglycidyl ether YED216D (manufactured by Mitsubishi Chemical Corporation), 1140 g of water, 100 g of a POE/POP-based emulsifier P123 (manufactured by Sigma-Aldrich Co. LLC) represented in Formula (1) described above, and 60 g of POE acetylene glycol-based SURFYNOL 465 (manufactured by Nissin Chemical co., ltd.) represented in Formula (2) described above as a permeation enhancer were added, and were stirred at a room temperature for 10 minutes, and thus, 1900 g of an undiluted solution of a comparative liquid crosslinking agent 2 in which the concentration of a non-volatile component was 40% by mass was obtained.

The undiluted solution was transported and stored in a storage container, water was added immediately before coating, and the container was shaken with a hand for 1 minute, and thus, the undiluted solution was diluted such that the concentration of the non-volatile component was 15% by mass, and a comparative coating fluid 2 of the liquid crosslinking agent was obtained.

### Comparative Example 3

<Production of Comparative Liquid Crosslinking Agent 3 and Comparative Coating Fluid 3 of Liquid Crosslinking Agent>

A comparative liquid crosslinking agent 3 and a comparative coating fluid 3 of the liquid crosslinking agent were obtained as with the production of the liquid crosslinking agent 4 and the coating fluid 4 of the liquid crosslinking agent except that permeation enhancer was not used.

### Comparative Example 4

<Production of Comparative Liquid Crosslinking Agent 4 and Comparative Coating Fluid 4 of Liquid Crosslinking Agent>

A comparative liquid crosslinking agent 4 and a comparative coating fluid 4 of the liquid crosslinking agent were obtained as with the production of the liquid crosslinking agent 6 and the coating fluid 6 of the liquid crosslinking agent except that permeation enhancer was not used.

### Comparative Example 5

<Production of Comparative Liquid Crosslinking Agent 5>

The production of a comparative liquid crosslinking agent 5 was attempted as with the production of the liquid crosslinking agent 7 except that POE acetylene glycol-based SURFYNOL 465 (manufactured by Nissin Chemical co., ltd.) represented in Formula (2) described above was used as an emulsifier instead of the POE/POP-based emulsifier P123 (manufactured by Sigma-Aldrich Co. LLC) represented in Formula (1) described above, but emulsification was not available, and liquid-liquid separation occurred, and thus, it was not possible to produce the liquid crosslinking agent.

[Measurement for Contact Angle]

A contact angle of the coating fluid of the liquid crosslinking agent (the liquid crosslinking agent with respect to a specific poly(ethylene-methacrylic acid) film prepared by the method described above when preparing an aqueous dispersion in which the concentration of a non-volatile component was 15% by mass) of Examples 1 to 10 and Comparative Examples 1 to 4 was examined by measuring a static contact angle with a CA-VP type automatic contact angle meter manufactured by Kyowa Interface Science Co., Ltd. In this case, FAMAS manufactured by Kyowa Interface Science Co., Ltd. was used as analysis software. In the measurement, values of 5 spots were measured, and an average value was calculated.

[Test for Storage Stability of Liquid Crosslinking Agent and Coating Fluid of Liquid Crosslinking Agent]

For the liquid crosslinking agent of Examples 1 to 10 and Comparative Examples 1 to 4, storage stability was evaluated as follows from the appearance immediately after producing the liquid crosslinking agent and after a lapse of one week.

◯: The separation of the liquid, and the aggregation and the precipitation of the non-volatile component were not observed.

Δ: The separation of the liquid, and the aggregation and the precipitation of the non-volatile component were partially observed, but the original state returned by a shake with a hand for 1 minute.

x: The separation of the liquid, and the aggregation and the precipitation of the non-volatile component were partially observed, and the original state did not return by a shake with a hand for 1 minute.

Further, for the coating fluid of the liquid crosslinking agent of Examples 1 to 10 and Comparative Examples 1 to 4, a volume average particle diameter immediately after producing the coating fluid of the liquid crosslinking agent and after a lapse of one week was evaluated. The volume average particle diameter was obtained from a particle size distribution measured by dynamic light scattering method. Results are shown in Table 1.

[Evaluation Test for Coating Properties/Water Resistance of Coating Fluid of Liquid Crosslinking Agent]

An aqueous solution of polyethylene imine was coated on the entire surface of a polyethylene terephthalate substrate to have a thickness of 0.2 μm, and then, was dried, and thus, a coating layer was formed. An ink containing a poly(ethylene-methacrylic acid) resin was further printed (Printing Thickness: approximately 5 μm) on the coating layer, and thus, a printing layer was formed. The coating fluid of the liquid crosslinking agent of Examples 1 to 10 and Comparative Examples 1 to 4 was coated on the entire surface of the printing layer by a wire bar coating method such that the mass of the non-volatile component after drying was a coating amount of 0.3 g/m², and coating properties (a defect such as application unevenness and cissing) thereof were evaluated on the basis of the following criteria.

Further, the substrate was dried in an oven at 120° C. for 30 minutes, and then, dipped in water for 30 minutes, and then, a tape peeling test was performed after lightly wiping the surface, on the basis of ASTM D3330 by using a masking tape (manufactured by 3M Company, Produce Name: Scotch (Registered Trademark) mending tape 810), and water resistance was evaluated on the basis of the following criteria.

<Coating Properties>

◯: There were no cissing and unevenness, and the coating fluid was homogeneously coated.

Δ: There were partial cissing and unevenness, but the coating fluid was approximately homogeneously coated.

x: There were cissing and unevenness, and the coating fluid was not homogeneously coated.

<Water Resistance>

◯: Peeling was not observed in the tape peeling test.

Δ: Peeling was partially observed in the tape peeling test.

x: Peeling was observed in the tape peeling test.

The measurement and evaluation results described above are collectively shown in Table 1.

TABLE 1

| | | | | | Conc. of non-volatile |
|---|---|---|---|---|---|
| | | | | Permeation | component of liquid |
| | Liquid | | Emulsifier | enhancer | crosslinking agent |
| | crosslinking | Epoxy | (parts by | (parts by | (content of water) |
| | agent | compound | mass) (1) | mass) (1) | (% by mass) |
| Example 1 | Liquid | YX8034/ | P123 | 465 | 100 |
| | crosslinking | YED216D | (17) | (10) | (0) |
| | agent 1 | | | | |
| Example 2 | Liquid | YX8034/ | P123 | 465 | 80 |
| | crosslinking | YED216D | (17) | (10) | (20) |
| | agent 2 | | | | |
| Example 3 | Liquid | YX8034/ | P123 | 465 | 62 |
| | crosslinking | YED216D | (17) | (10) | (38) |
| | agent 3 | | | | |
| Example 4 | Liquid | YX8034/ | EA177D | 465 | 100 |
| | crosslinking | YED216D | (25) | (10) | (0) |
| | agent 4 | | | | |
| Example 5 | Liquid | YED216D | P123 | 465 | 100 |
| | crosslinking | | (8) | (5) | (0) |
| | agent 5 | | | | |
| Example 6 | Liquid | YX8034/ | EA207D | 465 | 62 |
| | crosslinking | YED216D | (11) | (10) | (38) |
| | agent 6 | | | | |
| Example 7 | Liquid | YX8034/ | P123 | None | 100 |
| | crosslinking | YED216D | (17) | | (0) |
| | agent 7 | | | | |
| Example 8 | Liquid | EX-920 | P123 | 465 | 100 |
| | crosslinking | | (8) | (5) | (0) |
| | agent 8 | | | | |
| Example 9 | Liquid | EX-721 | P123 | 465 | 100 |
| | crosslinking | | (8) | (5) | (0) |
| | agent 9 | | | | |
| Example 10 | Liquid | O-130P | P123 | 465 | 100 |
| | crosslinking | | (8) | (5) | (0) |
| | agent 10 | | | | |
| Comp. | Comp. liquid | YX8034/ | P123 | 465 | 60 |
| Example 1 | crosslinking | YED216D | (10) | (10) | (40) |
| | agent 1 | | | | |
| Comp. | Comp. liquid | YED216D | P123 | 465 | 40 |
| Example 2 | crosslinking | | (17) | (10) | (60) |
| | agent 2 | | | | |
| Comp. | Comp. liquid | YX8034/ | EA177D | None | 100 |
| Example 3 | crosslinking | YED216D | (25) | | (0) |
| | agent 3 | | | | |
| Comp. | Comp. liquid | YX8034/ | EA207D | None | 62 |
| Example 4 | crosslinking | YED216D | (11) | | (38) |
| | agent 4 | | | | |

| | | | Volume average particle | | | |
|---|---|---|---|---|---|---|
| | | | diameter of epoxy compound | | | |
| | | | of coating fluid of liquid | | Coating properties/ | |
| | | | crosslinking agent | | water resistance of | |
| | | | (concentration of non-volatile | | coating fluid of | |
| | Contact angle | Storage | component of 15% by mass) (mm) | | liquid crosslinking | |
| | of liquid | stability of | | After | agent | |
| | crosslinking | liquid | Immediately | lapse | Coating | Water |
| | agent (°) | crosslinking | after prod- | of one | prop- | resis- |
| | (2) | agent | uction | week | erties | tance |
| Example 1 | 35.2 | ∘ | 0.5 | 0.5 | ∘ | ∘ |
| Example 2 | 36.0 | Δ | 0.2 | 0.7 | ∘ | ∘ |
| Example 3 | 36.3 | Δ | 0.2 | 0.8 | ∘ | ∘ |
| Example 4 | 39.0 | ∘ | 0.2 | 0.2 | ∘ | ∘ |
| Example 5 | 33.8 | ∘ | 0.2 | 0.2 | ∘ | ∘ |
| Example 6 | 39.3 | Δ | 0.6 | 0.7 | ∘ | ∘ |
| Example 7 | 39.8 | ∘ | 0.5 | 0.6 | Δ | Δ |
| Example 8 | 36.4 | ∘ | 0.1 | 0.1 | ∘ | ∘ |
| Example 9 | 36.1 | ∘ | 0.1 | 0.1 | ∘ | ∘ |
| Example 10 | 37.8 | ∘ | 0.5 | 0.5 | ∘ | ∘ |
| Comp. | 35.5 | x | 0.5 | 2.5 | ∘ | x |
| Example 1 | | | | | | |
| Comp. | 37.0 | x | 0.8 | 1.3 | ∘ | x |
| Example 2 | | | | | | |
| Comp. | 53.3 | ∘ | 0.2 | 0.2 | x | x |
| Example 3 | | | | | | |
| Comp. | 44.9 | ∘ | 0.6 | 0.6 | x | x |
| Example 4 | | | | | | |

(1) Parts by mass with respect to 100 parts by mass of epoxy compound
(2) Contact angle of liquid crosslinking agent with respect to poly (ethylene-methacrylic acid) film when preparing water dispersion liquid of concentration of non-volatile component of 15% by mass

From the results shown in Table 1, it is found that the liquid crosslinking agent and the coating fluid of the liquid crosslinking agent of the invention are excellent in the storage stability, the coating properties, and the water resistance. On the other hand, in the comparative liquid crosslinking agents 1 and 2 in which the content of water was greater than 39% by mass, the storage stability was degraded, the separation of the component and the attachment to the container were observed, and an increase in the particle diameter due to the aggregation, and the precipitation were observed even in the case of the diluted coating fluid. In addition, it was found that in the comparative liquid crosslinking agents 3 and 4 in which the contact angle with respect to the poly(ethylene-methacrylic acid) film when preparing the aqueous dispersion in which the concentration of the non-volatile component was 15% by mass was 42.0°, the coating properties and the water resistance were degraded.

### INDUSTRIAL APPLICABILITY

The liquid crosslinking agent of the invention is used for producing and processing a painted product, a printed product, packing material, and the like, in which mechanical durability, thermal durability, and water resistance are required. Specifically, the liquid crosslinking agent is preferably used for an application such as a painted product/printed product such as a mark, an advertisement, a poster, a signage, and a menu, a food and industrial packing material such as a label, a pouch, and a bag, an ornamental film for an electronic product, a vehicle or an airplane, an architectural material, an ornament, a smart phone, and the like.

1. A liquid crosslinking agent, comprising:
an epoxy compound; and
an emulsifier;
wherein:
a content of water in the liquid crosslinking agent is 39% by mass or less based on a total amount of liquid in the liquid crosslinking agent; and
when the liquid crosslinking agent is provided in an aqueous dispersion having a concentration of non-volatile components of 15% by mass or less, the aqueous dispersion has a contact angle with respect to a poly(ethylene-methacrylic acid) film of 42.0° or less.

2. The liquid crosslinking agent according to claim 1, wherein the epoxy compound is a compound having two or more epoxy groups.

3. The liquid crosslinking agent according to claim 1, wherein the emulsifier comprises a nonionic surfactant.

4. The liquid crosslinking agent according to claim 1, further comprising a permeation enhancer.

5. The liquid crosslinking agent according to claim 1, wherein the content of water in the liquid crosslinking agent is 0.1% by mass or less.

6. The liquid crosslinking agent according to claim 1, wherein a content of organic solvents in the liquid crosslinking agent is 0.1% by mass or less based on the total amount of liquid in the liquid crosslinking agent.

7. The liquid crosslinking agent according to claim 1, wherein, when water is added to the liquid crosslinking agent such that a content of non-volatile components in a resulting mixture is 15% by mass, and the mixture is shaken for 1 minute with a weak stirring force, an average particle diameter of the epoxy compound in the shaken mixture is 1 μm or less.

8. A method of preparing a coating fluid, comprising diluting the liquid crosslinking agent according to claim 1 with water.

9. A coating fluid, comprising the liquid crosslinking agent according to claim 1 diluted with water.

10. The coating fluid according to claim 9, wherein a concentration of non-volatile components in the coating fluid is 10% by mass or more.

11. A substrate, comprising a coating layer or a printing layer, wherein the coating layer or the printing layer has a crosslinking structure of the liquid crosslinking agent according to claim 1.

12. A coating method, comprising:
applying the coating fluid of claim 9 to a coating layer or a printing layer of a substrate; and
heating the coating layer or the printing layer.
